(19) United States
(12) Patent Application Publication
(10) Pub. No.: US 2003/0181098 A1
(43) Pub. Date: Sep. 25, 2003

(54) Plug-in connecting element for optoelectrical devices or subassemblies and plug-in connector with two plug-in connecting elements of this type

(76) Inventors: Jorg-Reinhardt Kropp, Berlin (DE); Gustav Muller, Osterhofen (DE)

Correspondence Address: LERNER AND GREENBERG, P.A., POST OFFICE BOX 2480, HOLLYWOOD, FL, 33022-2480, US

(21) Appl. No.: 10/395,429

(22) Filed: Mar. 24, 2003

(30) Foreign Application Priority Data
Mar. 22, 2002 (DE) 102 14 223.8

(51) Int. Cl. H01R 9/22

(52) U.S. Cl. 439/577; 439/894

(57) ABSTRACT

A plug-in connecting element is used in optoelectrical devices or subassemblies that have optical components and electrical components, and also in a plug-in connector having two plug-in connecting elements of this type. The plug-in connecting element has in a basic body, at least one electrical interface and at least one optical interface, which can be jointly connected in a pluggable manner to a matching plug-in connecting element. The plug-in connecting element is distinguished by the fact that electrical and optical paths are combined by the integration of an electrical interface and an optical interface in one plug-in connecting element.

### BACKGROUND OF THE INVENTION

Field of the Invention

The invention relates to a plug-in connecting element for optoelectrical devices or subassemblies which have optical components and electrical components, and also a plug-in connector with two plug-in connecting elements of this type.

In electronic systems such as computers or switching systems, optical transmission methods are increasingly being chosen for the distribution of high-frequency signals. The corresponding systems generally have a large number of optoelectrical devices, which in each case have separate optical and electrical interfaces.

For connecting such interfaces, it is known to connect them permanently by soldering or adhesive bonding or alternatively to form them in a pluggable, i.e. releasable, manner. In this respect, there are known in connection with printed circuit boards that have not only electrical paths but also optical paths (known as planar optical circuits) configurations in which the electrical connections are soldered and the optical connections are plugged by a separate part. Furthermore, in backplane technology, there are known configurations in which not only electrical plug-in connectors but also mechanical receptacles for optical plugs are contained in an edge connector.

### SUMMARY OF THE INVENTION

It is accordingly an object of the invention to provide a plug-in connecting element for optoelectrical devices or subassemblies and plug-in connector with two plug-in connecting elements that overcomes the above-mentioned disadvantages of the prior art devices of this general type, which permit the connection and coupling of optoelectrical devices and subassemblies in electronic systems in a simple way.

With the foregoing and other objects in view there is provided, in accordance with the invention, a combination of a device being an optoelectrical device or subassembly having optical components and electrical components, with a plug-in connecting element. The plug-in connecting element contains a basic body to be jointly connected in a pluggable manner to a matching plug-in connecting element, at least one electrical interface disposed in the basic body, and at least one optical interface disposed in the basic body.

The solution according to the invention is accordingly distinguished by the fact that the plug-in connecting element has the basic body that forms both the electrical interface and the optical interface, which can be jointly connected in a pluggable manner to a matching plug-in connecting element. The plugging of the plug-in connecting element correspondingly has the effect of simultaneously setting up electrical and optical connections. This leads to a considerable simplification of the connecting technique between individual optoelectrical components.

The invention is consequently distinguished by novel plug-in connecting elements in which electrical and optical paths are combined by the integration of an optical interface and an electrical interface into the basic body of one plug-in connecting element. The connection of the interfaces to corresponding interfaces of a matching plug-in connecting element takes place in a common plugging-in operation.

The solution according to the invention is of particular advantage in connection with printed circuit boards in which both optical and electrical paths are formed, since it permits simple coupling of optoelectrical components on printed circuit boards of this type.

It is pointed out that, for the purposes of the invention, an electrical interface or an optical interface is that configuration with at least one electrically or optically effective part which can be electrically or optically coupled to an electrically or optically effective part of a matching coupling element.

In a preferred refinement of the invention, the basic body contains as elements of the electrical interface conducting contacts that can be connected to electrical and/or optoelectrical components via corresponding electrical paths. The optical interface is preferably formed by at least one light-shaping or light-conducting element, in particular passive optical elements such as lenses, mirrors or optical waveguides.

The electrical interface and the optical interface are preferably formed next to each other in regions of the basic body which are separate from each other, in order to separate the respective functionalities spatially in spite of allowing them to be plugged in together. In principle, however, it is also conceivable for the electrical interface and the optical interface to be formed at least partly in the same region of the plug, the interfaces for example having alternately disposed elements or penetrating one into the other.

In a preferred refinement of the invention, the plug-in connecting element is firmly mounted on an optoelectrical device or an optoelectrical subassembly, the electrical interface and the optical interface respectively being coupled by electrical components or optical components of the device or the subassembly. The plug-in connecting element is in this case connected to the device or the subassembly for example by soldering or adhesive bonding.

When connecting two plug-in connecting elements which are respectively connected to an optoelectrical device or an optoelectrical subassembly, also considered to include a printed circuit board with a planar optical circuit, optical paths between the plugged devices or subassemblies are created by the optical interfaces or plug-in connecting elements coupled to each other. Electrically conducting contacts are produced via the electrical interfaces. An optoelectrical device firmly connected to a plug-in connecting element can consequently be electrically and optically connected to another optoelectronic device in one plugging-in operation.

The basic body preferably is formed of an optically transparent material, so that the optical interface can be formed by the basic body itself. It is, for example, cuboidally formed.

Pluggable mechanical contours, which permit a pluggable connection with a matching plug-in connecting element that has corresponding mechanical contours are formed in the basic body and/or the optical interface. The mechanical structures bring about an exact alignment of the optical and electrical channels of two matching plug-in connecting elements.

In a preferred refinement of the invention, the optical interface is formed in one piece with the basic body, the latter then consisting of an optically transparent material. Alternatively, the optical interface is formed of a separate material. It can, for example, be connected in a pluggable manner to the basic body, for instance it can be inserted into a corresponding receptacle or opening of the basic body. It may also be provided that the basic body and the optical interface, are formed of different materials, are produced by the two-component injection-molding technique. Forming the optical interface from a different material opens up the possibility in particular of forming the optical interface from a different material than the basic body and in this way optimizing the respective functions.

In a preferred development of the invention, a deflecting device for deflecting optical rays into the optical interface is provided in the optical interface. For example, the plug-in connecting element is mounted on a printed circuit board with a planar optical circuit and light signals in an optical waveguide of the planar optical circuit are diverted by the deflecting device into the optical interface and passed on from the latter to a matching plug-in connecting element.

It is pointed out that the mounting planes and/or connecting planes of the electrical interface and of the optical interface on the printed circuit board or on an optoelectrical device or on an optoelectrical subassembly may be different. This has no effect on the functional properties of the plug-in connecting element. In this respect, it may also be provided that the mounting surfaces of the electrical interface and of the optical interface on a printed circuit board run perpendicular to each other, for example if the optical interface is coupled onto the end face of the printed circuit board. It may also be provided that the optical interface has outer contours which permit adjustment-free coupling and connection of the plug-in connecting element or of the optical interface to the printed circuit board.

Furthermore, it is pointed out that a printed circuit board is understood as meaning any supporting element that forms electrical and possibly also optical lines.

The invention also relates to a plug-in connection with two plug-in connecting elements as described above. The mechanical contours of the two plug-in connecting elements are in this case configured in such a way that they can be connected in a pluggable manner to each other. In this case, the respective optical and electrical interfaces are simultaneously coupled to each other. Optoelectrical devices or subassemblies connected to the plug-in connecting elements are connected to each other via optical and electrical paths that run over the same, common plug-in connection.

Other features which are considered as characteristic for the invention are set forth in the appended claims.

Although the invention is illustrated and described herein as embodied in a plug-in connection element for optoelectrical devices or subassemblies and a plug-in connector with two plug-in connecting elements of this type, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, sectional view of a first exemplary embodiment of a plug-in connector with two corresponding plug-in connecting elements, which respectively have an electrical and an optical interface, according to the invention;

FIG. 2 is a sectional view of a second exemplary embodiment of the plug-in connector with two corresponding plug-in connecting elements, of which the optical interface is respectively formed in a pluggable manner;

FIG. 3 is a sectional view of a third exemplary embodiment of the plug-in connector with two plug-in connecting elements, the one plug-in connecting element having a device for deflecting optical rays;

FIG. 4 is a sectional view showing a use of the plug-in connector of FIG. 3 in the case of a pluggable connection between an optoelectrical subassembly and a printed circuit board with optical paths;

FIG. 5 is a view of a fourth exemplary embodiment of the plug-in connector with two plug-in connecting elements, in which the coupling planes for an electrical coupling and an optical coupling to a printed circuit board are perpendicular to each other; and

FIG. 6 is a view of an exemplary embodiment corresponding to FIG. 5, the optical interface of the one plug-in connecting element having contours for adjustment-free connection to a printed circuit board.

### DESCRIPTION OF THE PREFERRED EMBODIMENTS

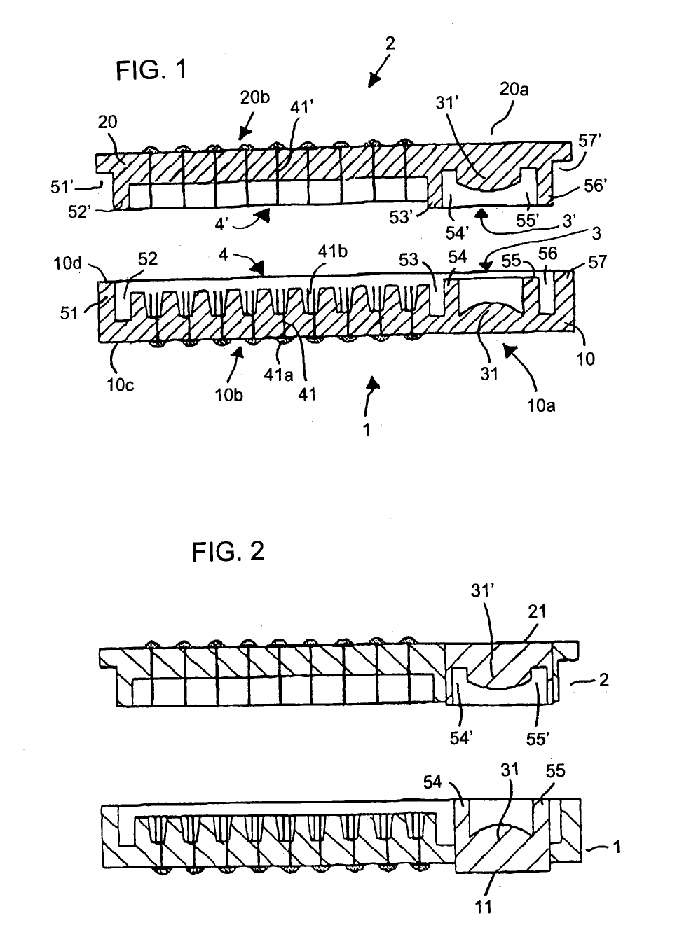

Referring now to the figures of the drawing in detail and first, particularly, to FIG. 1 thereof, there is shown a first exemplary embodiment of a plug-in connector with two plug-in connecting elements 1, 2, which form mutually corresponding structures and can be connected to each other in a pluggable manner.

The one plug-in connecting element 1, which forms the female part of the plug-in connector, contains a basic body 10 formed of an optically transparent material. The basic body 10 has a first region 10a and a second region lob, which are formed next to each other and respectively form an optical interface 3 and an electrical interface 4 or an optically effective plug region and an electrically effective plug region. The optical interface 3 is formed by at least one passive optical element, in the exemplary embodiment represented a lens 31, which is formed in one piece from the material of the basic body 10.

The electrical interface 4 is formed by a multiplicity of electrically conducting contacts 41, which are embedded in the basic body 10. The electrical contacts 41 are only schematically represented in FIG. 1 and may also be configured in some other way. In the exemplary embodiment represented, the contacts 41 form on a side 10c of the basic body facing away from the matching coupling element 2 contact pads 41a, by which electrical connection can be established, for example in relation to conductor tracks of a printed circuit board. On a side 10d of the basic body 10 facing the matching coupling element 2, the electrical contacts 41 have electrical receptacles 41b for the electrical contacts of the matching coupling element 2.

Also formed on the basic body 10 are a multiplicity of mechanical guiding structures, which in conjunction with corresponding guiding structures of the matching coupling element 2 permit exact plugging, with suitable alignment of the electrical and optical paths or channels. The mechanical guiding contours are formed by projections and clearances 51 to 57. In this respect, it is pointed out that the guiding structures are also formed in the region of the optical interface (projections and clearances 53, 54, 55, 56).

The matching plug-in connecting element is formed by a further plug-in connecting element 2, which in a corresponding way has a basic body 20 with a first region 20a, which forms an optical interface 3′, and a second region 20b, which forms an electrical interface 4′. The optical interface 3′ is in turn formed by an optical lens 31′ and the electrical interface 4′ is in turn formed by electrical contacts 41′. The second plug-in connecting element 2 is the male part of the plug-in connector between the two plug-in connecting elements 1, 2, so that the electrical contacts 41′ are correspondingly formed. The configuration represented of the electrical contacts 41′ and of the passive optical element 31′, forming the optical interface 3′, is in turn only to be understood by way of example.

The guiding contours 51′ to 57′ provided in the case of the second plug-in connecting element 2 correspond exactly to the corresponding guiding structures 51 to 57 of the other plug-in connecting element 1, so that exact and substantially play-free plugging is possible between the two plug-in connecting elements 1, 2.

When the two plug-in connecting elements 1, 2 are plugged, an optical coupling between the two optical interfaces 3, 3′ and an electrical coupling between the electrical interfaces 4, 4′ is provided simultaneously in one plugging-in operation. An optical path is provided via the passive optical elements 31, 31′ and an electrical path is provided via the electrical contacts 41, 41′ between the plug-in connecting elements 1, 2.

The mounting of the plug-in connecting elements 1, 2 on assigned subassemblies may take place for example in such a way that the paths of rays through the respective lens 31, 31′ emerge from the assigned subassembly in parallel. The parallel paths of rays are optically coupled to each other by the plugging.

The exemplary embodiment of FIG. 2 differs from the exemplary embodiment of FIG. 1 to the extent that the optical interfaces 3, 3′ are formed by separate parts 11, 21, which are connected to the basic body 1, 2. The separate parts 11, 21 in this case form the passive optical elements 31, 31′. This configuration allows the optical interface or the optically effective parts 31, 31′ to be formed from a different material than the material of the basic body 1, 2. This permits an optimization of the respective functions.

It is pointed out that guiding structures 54, 55, 54′, 55′ are also realized on the optically effective parts 11, 21.

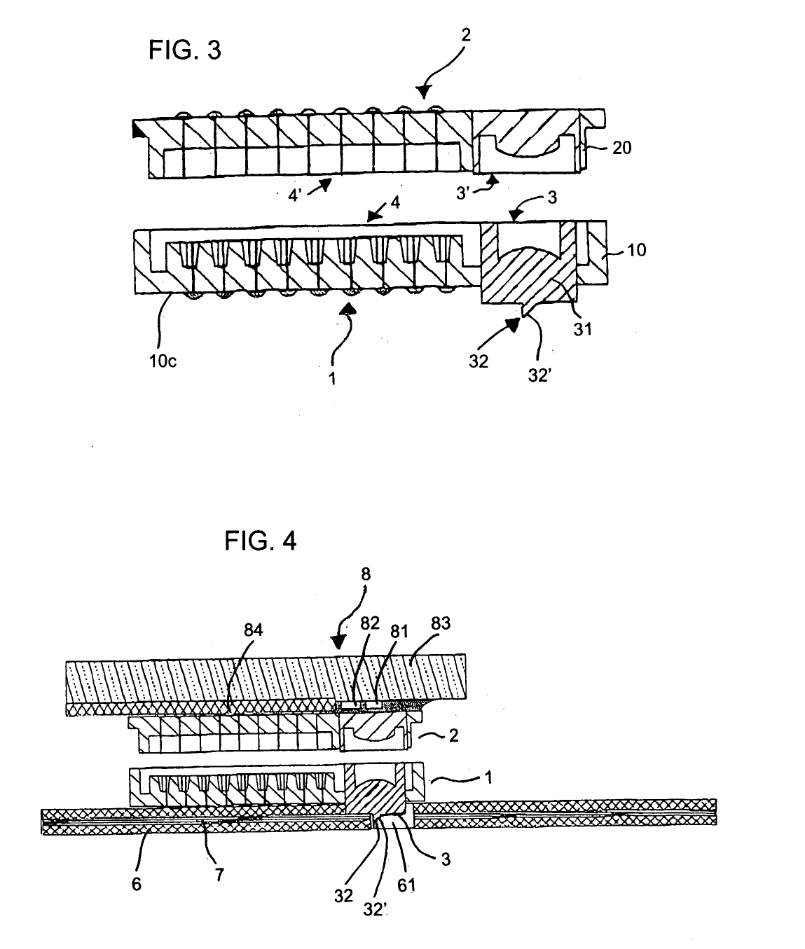

The exemplary embodiment of FIG. 3 shows the plug-in connector having the two plug-in connecting elements 1, 2, in which the optical interface 3 of the one plug-in connecting element 1 has on the side 10c facing away from the matching coupling element 2 a deflecting device via which light is deflected into the optical interface 3 or the passive optical element 31. In the exemplary embodiment represented, the deflecting device contains a projection 32, which has a sloping mirror surface 32′, via which light is deflected perpendicularly and conducted on an optical axis of the lens 31. In the exemplary embodiment of FIG. 3, the deflecting device 32 is formed on the optical interface 3 and is formed of a different material in a way corresponding to FIG. 2. However, in principle they may similarly be formed on the optical interface 3 that is formed as one part with the basic body 10.

FIG. 4 shows a use of the plug-in connector shown in FIG. 3 when connecting the one plug-in connecting element 1 to a printed circuit board 6 and the other plug-in connecting element 2 to an optoelectrical subassembly 8.

Provided in this case is the printed circuit board 6 which contains an optical waveguide 7, which transmits optical signals to be transmitted. In addition, the printed circuit board 6 has, in a way known per se, electrical connections.

Formed in the printed circuit board 6 is an opening 61, which interrupts the optical waveguide 7. The one plug-in connecting element 1 is then placed onto the printed circuit board 6 in such a way that the optical element 31 and the deflecting device 32 protrude into the opening 61 of the printed circuit board 6, to be precise in such a way that light emerging from the optical waveguide 7 is coupled out via the mirror surface 32′ of the deflecting device 32 perpendicularly in relation to the printed circuit board 6 in a way corresponding to the arrow A. The opening 61 in the printed circuit board 6 is in this case dimensioned in such a way that a passive adjustment of the plug-in connecting element 1 with respect to the printed circuit board 6 can take place.

An electrical coupling between the electrical interface 4 of the plug-in connecting element 1 and electrical lines on the printed circuit board 6 (not separately represented) takes place in a way known per se by a soldered connection.

It is pointed out that the connecting planes for the electrical connection and the optical connection of the plug-in connecting element 1 with the printed circuit board 6 are different: the electrical connecting plane is defined by the plane of the electrical soldered contacts and lies on the surface of the printed circuit board 6; the optical connecting plane runs offset from this, on account of the protrusion of the optically effective plug region into the printed circuit board 6, and in the plane in which the optical waveguide 7 runs.

The other plug-in connecting element 2 is connected to the schematically represented optoelectrical subassembly 8. In the exemplary embodiment represented, which is to be understood as given only by way of example, the subassembly 8 contains a receiving diode 81 with an assigned preamplifier 82, which are disposed on a substrate 83. Additionally provided on the substrate 83 are electrical lines 84, which are schematically represented and are electrically coupled to the electrical contacts 41′ of the plug-in connecting element 2.

The optoelectrical subassembly 8 may be configured in any way desired and, for example, perform even complex electrical functions or contain a microprocessor.

When plugging the two plug-in connecting elements 1, 2 together, light coupled out from the optical waveguide 7 is directed via the two optical interfaces 3, 3′ onto the receiving diode 81. The two optical interfaces 3, 3′ in this case provide an optical path of the plug-in connection. If the one element 81 of the subassembly 8 is formed as a transmitting element, the path of rays is reversed.

At the same time, the connection of the two electrical interfaces 4, 4′ also has the effect of establishing an electrical connection between the optoelectrical subassembly 8 and the printed circuit board 6 or further electrical or optoelectrical devices or subassemblies disposed on the printed circuit board 6.

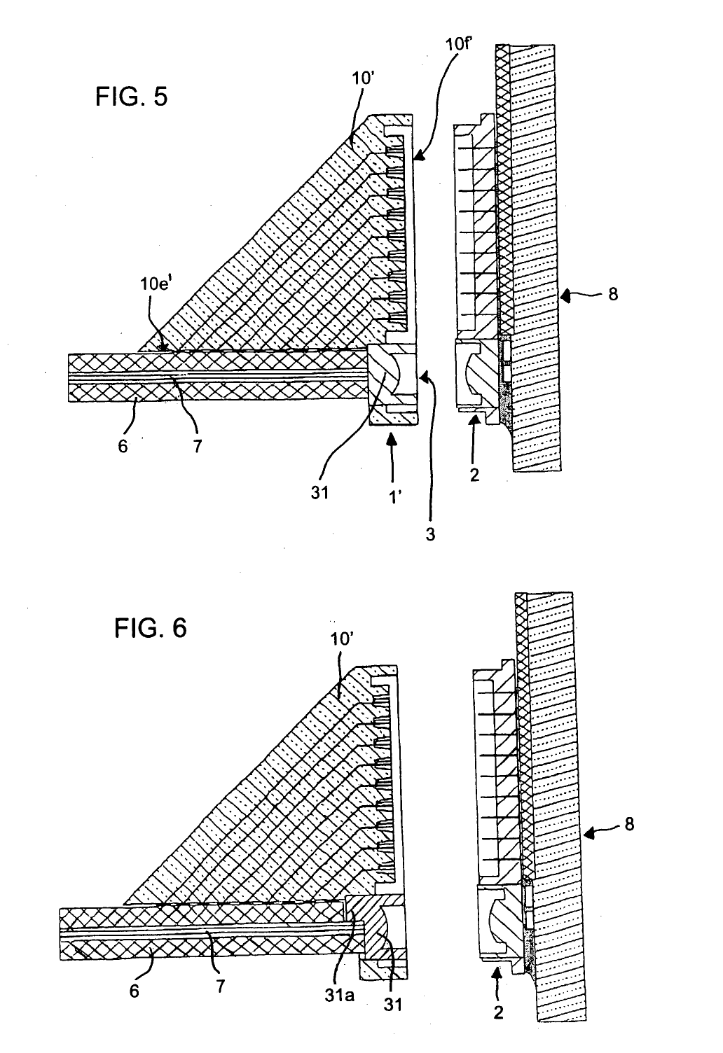

FIGS. 5 and 6 show an optoelectrical socket, in which the coupling planes of the electrical paths and the optical paths on the printed circuit board 6 are perpendicular to each other.

According to FIG. 5, the optical interface 3 of a plug-in connecting element 1′ is disposed on the end face of the printed circuit board 6, so that the optical coupling plane runs perpendicularly in relation to the surface of the printed circuit board 6. With this orientation, optical signals of the optical waveguide 7 of the printed circuit board 6 can be coupled into the plug-in connecting element 1 or the optical interface 3 without deflection.

For the electrical coupling of the electrical interface 4 to the printed circuit board 6, a basic body 10′ of the plug-in connecting element 1 is formed triangularly in section with two perpendicularly running sides 10e′, 10f′, between which the electrical contacts 41 run around the basic body 10′. The one side 10f′ forms the actual interface and, together with the optically effective region 3 of the plug 1′, forms the coupling region in relation to the matching coupling element 2. On the other side 10e′, the contacting of the electrical interface with respect to the printed circuit board 6 takes place by soldering. The coupling planes of the electrical paths and the optical paths on the printed circuit board 6 are perpendicular to each other.

In the case of FIG. 6, it is additionally provided that the region of the optical interface or of the optical element 31 facing the printed circuit board 6 has outer contours 31a enclosing the printed circuit board 6, in order to permit a passive adjustment of the plug-in connecting element 1′ with respect to the printed circuit board by an automatic form fit.

In alternative configurational variants, the electrical terminals of FIGS. 5 and 6 are disposed in the same plane as the printed circuit board 6, i.e. they are located in front of and/or behind the optical interface, perpendicularly in relation to the plane of the drawing. As a result, the height of the construction can be reduced.

We claim:

1. In combination with a device selected from the group consisting of optoelectrical devices and optoelectrical subassemblies each having optical components and electrical components, a plug-in connecting element comprising:
a basic body to be jointly connected in a pluggable manner to a matching plug-in connecting element;
at least one electrical interface disposed in said basic body; and
at least one optical interface disposed in said basic body.

2. The plug-in connecting element according to claim 1, wherein said electrical interface has conducting contacts.

3. The plug-in connecting element according to claim 1, wherein said optical interface has at least one element selected from the group consisting of light-shaping elements and light-conducting elements.

4. The plug-in connecting element according to claim 3, wherein said optical interface has at least one passive optical element.

5. The plug-in connecting element according to claim 1, wherein said electrical interface and said optical interface are disposed next to each other in regions of said basic body which are separate from each other.

6. The plug-in connecting element according to claim 1, wherein said basic body is firmly mounted on the device, said electrical interface and said optical interface respectively being coupled by the electrical components and the optical components of the device.

7. The plug-in connecting element according to claim 6, wherein said basic body is connected to the device by at least one of soldering and adhesive bonding.

8. The plug-in connecting element according to claim 1, wherein said basic body is formed of an optically transparent material.

9. The plug-in connecting element according to claim 1, wherein at least one of said basic body and said optical interface has pluggable mechanical contours.

10. The plug-in connecting element according to claim 1, wherein said optical interface is formed in one piece with said basic body.

11. The plug-in connecting element according to claim 1, wherein said optical interface is formed of a material that is different from a material forming said basic body.

12. The plug-in connecting element according to claim 11, wherein said optical interface is connected in a pluggable manner to said basic body.

13. The plug-in connecting element according to claim 1, wherein said optical interface has a deflecting device for deflecting optical rays into said optical interface.

14. The plug-in connecting element according to claim 4, wherein said passive optical element is selected from the group consisting of lenses, mirrors and optical waveguides.

15. A plug-in connecting assembly, comprising:
a printed circuit board having optical paths; and
a plug-in connecting element mounted on said printed circuit board, said plug-in connecting element containing:
a basic body to be jointly connected in a pluggable manner to a matching plug-in connecting element;
at least one electrical interface disposed in said basic body; and
at least one optical interface disposed in said basic body.

16. The plug-in connecting assembly according to claim 15, wherein at least one of mounting planes and connecting planes of said electrical interface and of said optical interface on said printed circuit board run differently.

17. The plug-in connecting assembly according to claim 16, wherein said electrical interface and said optical interface have mounting surfaces disposed on said printed circuit board running perpendicular to each other.

18. The plug-in connecting assembly according to claim 16, wherein said optical interface has outer contours for permitting adjustment-free coupling and connection of said plug-in connecting element to said printed circuit board.

19. A plug-in connector, comprising:
a first plug-in connecting element having a first mechanical contour, a first basic body, at least one first electrical interface disposed in said first basic body, and at least one first optical interface disposed in said first basic body; and
a second plug-in connecting element having a second mechanical contour, a second basic body, at least one second electrical interface disposed in said second basic body, and at least one second optical interface disposed in said second basic body, said first and second mechanical contours connected in a pluggable manner to each other, said first and second optical interfaces being coupled to each other in a plugged in state, said first and second electrical interfaces being coupled to each other in the plugged in state.
